(19) United States
(12) Patent Application Publication
(10) Pub. No.: US 2026/0213871 A1
(43) Pub. Date: Jul. 23, 2026

(54) SEGMENT PARSER DESIGNS FOR UNEQUAL MODULATION AND UNEQUAL MCS TRANSMISSION

(71) Applicant: MEDIATEK INC., Hsinchu City (TW)

(72) Inventors: Shengquan HU, San Jose, CA (US); Jianhan LIU, San Jose, CA (US); Thomas Edward PARE, Jr., San Jose, CA (US)

(21) Appl. No.: 19/158,171

(22) PCT Filed: Mar. 29, 2024
(86) PCT No.: PCT/CN2024/085039

§ 371 Date: Aug. 20, 2025

Related U.S. Application Data
(60) Provisional application No. 63/493,066, filed on Mar. 30, 2023.
(60) Provisional application No. 63/461,934, filed on Apr. 26, 2023.

(51) Int. Cl. H04L 1/00; H04L 27/36

(52) U.S. Cl. CPC H04L 1/0003; H04L 1/007; H04L 27/364

(57) ABSTRACT

Various schemes pertaining to segment parser designs for unequal modulation (UEQM) and unequal modulation and coding scheme (MCS) transmission in wireless communications are described. An apparatus (e.g., station (STA)) generates a multi-resource unit (MRU) comprising an aggregate of a plurality of resource units (RUs). The apparatus then transmits the MRU with UEQM or unequal MCS.

### CROSS REFERENCE TO RELATED PATENT APPLICATION

The present disclosure is part of a non-provisional patent application claiming the priority benefit of U.S. Provisional Patent Application Nos. 63/493,066 and 63/461,934, filed 30 Mar. 2023 and 26 Apr. 2023, respectively, the contents of which being incorporated by reference in their entirety.

### TECHNICAL FIELD

The present disclosure is generally related to wireless communications and, more particularly, to segment parser designs for unequal modulation and unequal modulation and coding scheme (MCS) transmission in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and wireless local area network (WLAN) systems in accordance with one or more Institute of Electrical and Electronics Engineers (IEEE) 802.11be standards (e.g., IEEE 802.11ax/be), one user is always scheduled with one MCS or the same modulation for all resource units (RUs) in a multi-RU (MRU) and all spatial streams (SS) in a multiple-input-multiple-output (MIMO) transmission. In some application scenarios or channel conditions, different portions of the wireless spectrum may experience different interference levels. In particular, for the 6 GHz frequency band, there are three power modes, namely: standard power (SP), low power indoor (LPI), and very low power (VLP) modes. In a wider bandwidth, a user may transmit or may be assigned with resources across different power mode regions. To utilize the spectrum efficiently, scheduling different MCSs or modulation or quadrature amplitude modulation (QAM) levels for different spectral resources may improve overall system throughput and link reliability. Moreover, system throughput and reliability may also be improved by assigning unequal modulations (UEQM) on different frequency subblocks or RUs. For example, a primary 20 MHz subchannel (equivalent to a 242-tone RU (or RU242)) may have a higher signal-to-interference-and-noise ratio (SINR) than a secondary 20 MHz subchannel, thus the overall system throughput could be improved by scheduling a higher order modulation on the primary 20 MHz subchannel and a lower order modulation on the secondary 20 MHz subchannel. Therefore, there is a need for a solution of segment parser designs for unequal modulation and unequal MCS transmission in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to segment parser designs for unequal modulation and unequal MCS transmission in wireless communications. Thus, implementation of one or more segment parser designs proposed herein may be utilized for UEQM for MRUs in the frequency domain. Furthermore, implementation of one or more segment parser designs proposed herein may be utilized for per-subchannel or RU-based proportional round robin parser to enable UEQM operations in the frequency domain.

In one aspect, a method may involve generating an MRU comprising an aggregate of a plurality of RUs. The method may also involve transmitting the MRU with UEQM or with unequal MCS.

In another aspect, an apparatus may include a transceiver configured to communicate wirelessly and a processor coupled to the transceiver. The processor may generate an MRU comprising an aggregate of a plurality of RUs. The processor may also transmit, via the transceiver, the MRU with UEQM or with unequal MCS.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a diagram of an example design under a proposed scheme in accordance with the present disclosure.

FIG. 14 is a diagram of an example design under a proposed scheme in accordance with the present disclosure.

FIG. 15 is a block diagram of an example communication system under a proposed scheme in accordance with the present disclosure.

FIG. 16 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to segment parser designs for unequal modulation and unequal MCS transmission in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (RRU) refers to a RU with tones that are continuous (e.g., immediately adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, an aggregate (26+52)-tone regular multi-RU (MRU) may be interchangeably denoted as MRU78 (or RMRU78), an aggregate (26+106)-tone regular MRU may be interchangeably denoted as MRU132 (or RMRU132), and so on. Furthermore, a distributed-tone RU (DRU) refers to a RU with tones that are non-discontinuous (e.g., not immediately adjacent to one another) and interleaved, interlaced or otherwise distributed. Accordingly, a 26-tone distributed-tone RU may be interchangeably denoted as DRU26, a 52-tone distributed-tone RU may be interchangeably denoted as DRU52, a 106-tone distributed-tone RU may be interchangeably denoted as DRU106, a 242-tone distributed-tone RU may be interchangeably denoted as DRU242, a 484-tone distributed-tone RU may be interchangeably denoted as DRU484, a 996-tone distributed-tone RU may be interchangeably denoted as DRU996, a 2×996-tone distributed-tone RU may be interchangeably denoted as DRU2×996, and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

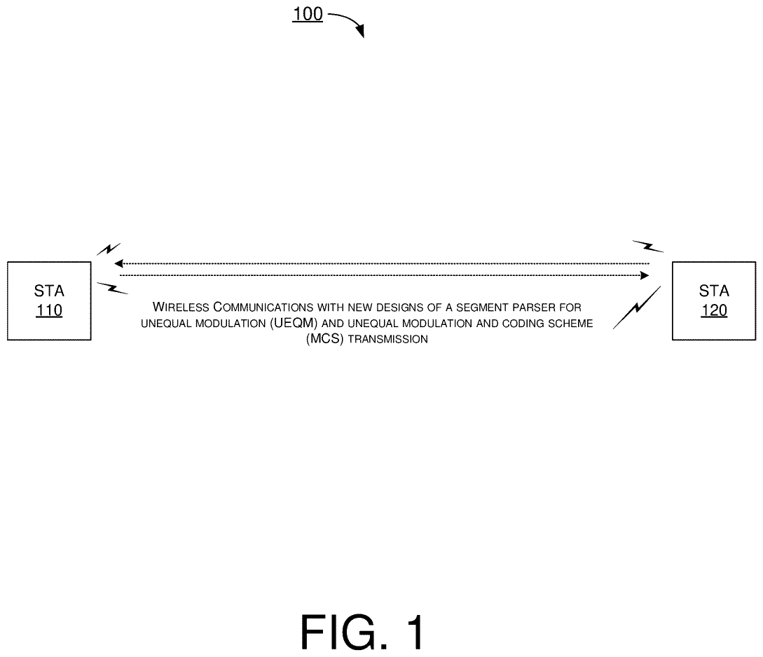

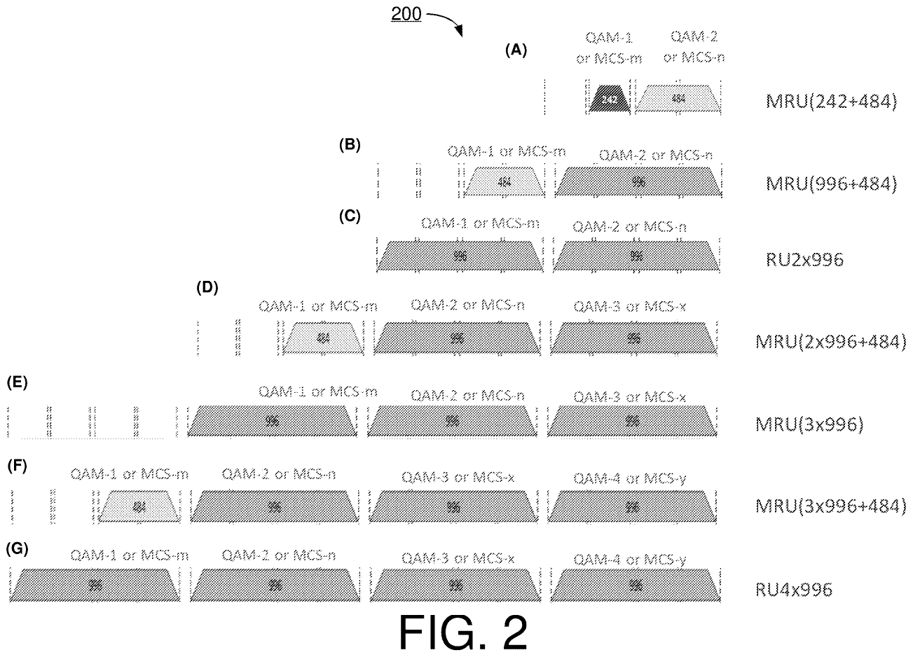

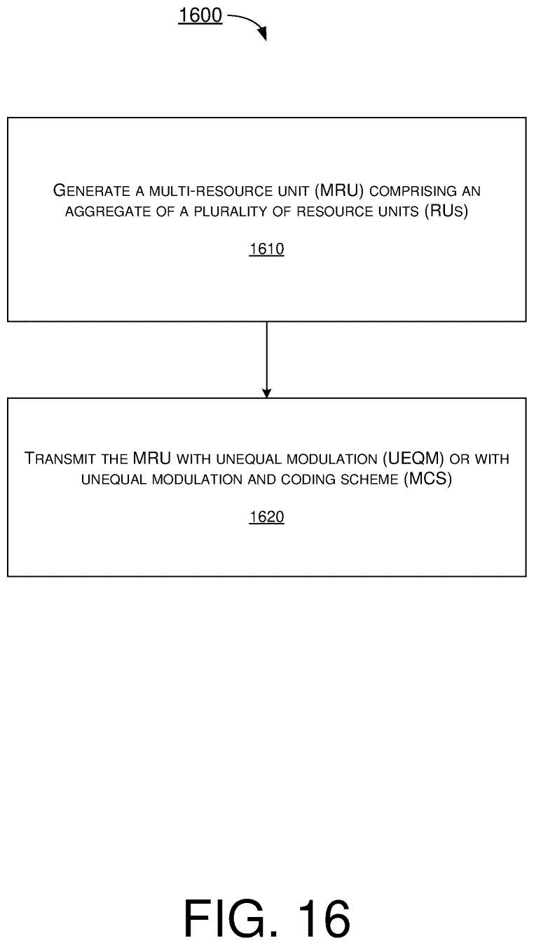

FIG. 1 illustrates an example network environment 100 in which various solutions and schemes in accordance with the present disclosure may be implemented. FIG. 2~FIG. 16 illustrate examples of implementation of various proposed schemes in network environment 100 in accordance with the present disclosure. The following description of various proposed schemes is provided with reference to FIG. 1~FIG. 16.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the segment parser designs for unequal modulation and unequal MCS transmission in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In IEEE 802.11be, segment parsing may be performed for RUs and/or MRUs of sizes greater than a 996-tone RU (RU996), such as 2×996, 996+484, 996+484+242, 2×996+484, 3×996+484, and 4×996. The segment parser in wireless communications under IEEE 802.11be is operated for equal modulation across all the RUs in a given MRU, in that: s=max(1, N_{bpscs,u}/2) for user u, with the same s being used for all the RUs in a given MRU. Here, s denotes a segment parser and N_{bpscs,u} denotes a number of coded bits per subcarrier per stream for user u. The segment parser outputs a bit sequence distribution that can be expressed by Expression 1 as follows:

$${y}_{k , I , u} = {x}_{m , u}$$

$$m = ( {\sum }_{i = 0}^{L - 1} {m}_{i} ) \cdot ⌊ \frac{k}{{m}_{I}} ⌋ + {\sum }_{i = 0}^{l - 1} {m}_{i} + ( k mod {m}_{I} )$$

If there are leftover bits, the leftover bits are processed as shown in Expression 2 as follows:

$$m = ( {\sum }_{i = 0}^{L - 1} {m}_{i} ) \cdot ⌊ \frac{{N}_{CBPSS , {I}_{0} , u}}{{m}_{{I}_{0}}} ⌋ + ( {\sum }_{i = 0 , i \neq {l}_{0}}^{L - 1} {m}_{i} ) \cdot ⌊ \frac{{k}^{′}}{{m}_{I}} ⌋ + {\sum }_{i = 0 , i \neq {l}_{0}}^{l - 1} {m}_{i} + ( k mod {m}_{I} )$$

FIG. 2 illustrates an example scenario 200 under a proposed scheme in accordance with the present disclosure. Scenario 200 may pertain to unequal modulation for MRUs. In particular, FIG. 2 shows examples of UEQM or unequal MCS transmission in the frequency domain for large MRUs of different sizes under the proposed scheme. Part (A) of FIG. 2 shows an example of UEQM or unequal MCS transmission of an MRU (242+484), which is an aggregate of RU242 and RU484, with a first QAM level (labeled as “QAM-1” in FIG. 2) or first MCS level (labeled as “MCS-m” in FIG. 2) applied to RU242 and with a second QAM level (labeled as “QAM-2” in FIG. 2) or second MCS level (labeled as “MCS-n” in FIG. 2) applied to RU484. Part (B) of FIG. 2 shows an example of UEQM or unequal MCS transmission of an MRU (996+484), which is an aggregate of RU996 and RU484, with a first QAM level (labeled as “QAM-1” in FIG. 2) or first MCS level (labeled as “MCS-m” in FIG. 2) applied to RU484 and with a second QAM level (labeled as “QAM-2” in FIG. 2) or second MCS level (labeled as “MCS-n” in FIG. 2) applied to RU996. Part (C) of FIG. 2 shows an example of UEQM or unequal MCS transmission of an MRU (2×996), which is an aggregate of two RU996s, with a first QAM level (labeled as “QAM-1” in FIG. 2) or first MCS level (labeled as “MCS-m” in FIG. 2) applied to a first RU996 and with a second QAM level (labeled as “QAM-2” in FIG. 2) or second MCS level (labeled as “MCS-n” in FIG. 2) applied to a second RU996. Part (D) of FIG. 2 shows an example of UEQM or unequal MCS transmission of an MRU (2×996+484), which is an aggregate of a RU484 and two RU996s, with a first QAM level (labeled as “QAM-1” in FIG. 2) or first MCS level (labeled as “MCS-m” in FIG. 2) applied to RU484, with a second QAM level (labeled as “QAM-2” in FIG. 2) or second MCS level (labeled as “MCS-n” in FIG. 2) applied to a first RU996, and with a third QAM level (labeled as “QAM-3” in FIG. 2) or third MCS level (labeled as “MCS-x” in FIG. 2) applied to a second RU996. Part (E) of FIG. 2 shows an example of UEQM or unequal MCS transmission of an MRU (3×996), which is an aggregate of three RU996s, with a first QAM level (labeled as “QAM-1” in FIG. 2) or first MCS level (labeled as “MCS-m” in FIG. 2) applied to a first RU996, with a second QAM level (labeled as “QAM-2” in FIG. 2) or second MCS level (labeled as “MCS-n” in FIG. 2) applied to a second RU996, and with a third QAM level (labeled as “QAM-3” in FIG. 2) or third MCS level (labeled as “MCS-x” in FIG. 2) applied to a third RU996. Part (F) of FIG. 2 shows an example of UEQM or unequal MCS transmission of an MRU (3×996+484), which is an aggregate of a RU484 and three RU996s, with a first QAM level (labeled as “QAM-1” in FIG. 2) or first MCS level (labeled as “MCS-m” in FIG. 2) applied to RU484, with a second QAM level (labeled as “QAM-2” in FIG. 2) or second MCS level (labeled as “MCS-n” in FIG. 2) applied to a first RU996, with a third QAM level (labeled as “QAM-3” in FIG. 2) or third MCS level (labeled as “MCS-x” in FIG. 2) applied to a second RU996, and with a fourth QAM level (labeled as “QAM-4” in FIG. 2) or fourth MCS level (labeled as “MCS-y” in FIG. 2) applied to a third RU996. Part (G) of FIG. 2 shows an example of UEQM or unequal MCS transmission of an MRU (4×996), which is an aggregate of four RU996s, with a first QAM level (labeled as “QAM-1” in FIG. 2) or first MCS level (labeled as “MCS-m” in FIG. 2) applied to a first RU996, with a second QAM level (labeled as “QAM-2” in FIG. 2) or second MCS level (labeled as “MCS-n” in FIG. 2) applied to a second RU996, with a third QAM level (labeled as “QAM-3” in FIG. 2) or third MCS level (labeled as “MCS-x” in FIG. 2) applied to a third RU996, and with a fourth QAM level (labeled as “QAM-4” in FIG. 2) or fourth MCS level (labeled as “MCS-y” in FIG. 2) applied to a fourth RU996.

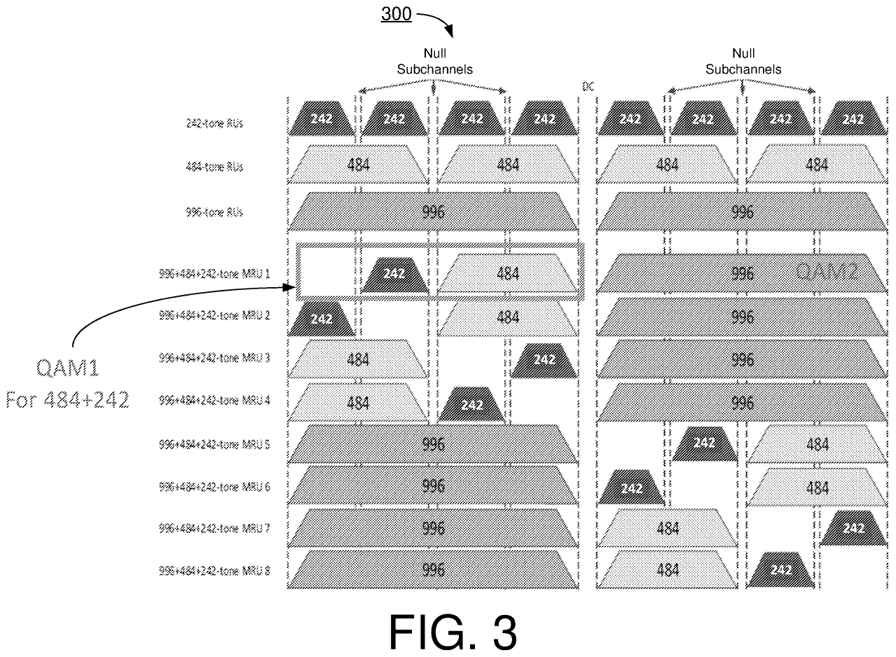

FIG. 3 illustrates an example scenario 300 under a proposed scheme in accordance with the present disclosure. Scenario 300 may pertain to unequal modulation for MRU (996+484+242). Referring to FIG. 3, for MRU (996+484+242) which is an aggregate of RU996, RU484 and RU242, it may be assumed that the same modulation or QAM level (labeled as “QAM1” in FIG. 3) may be applied or otherwise assigned to RU484+RU242 in one 80 MHz segment. Moreover, the RU996 may be assigned with a different QAM level (labeled as “QAM2” in FIG. 3) than that assigned to the RU484+RU242 of the same MRU (996+484+242). This is because, under the proposed scheme, RU/MRU within a first 80 MHz may be assigned with a first QAM level or first MCS level while RU/MRU within a second 80 MHz may be assigned with a second QAM level or second MCS level.

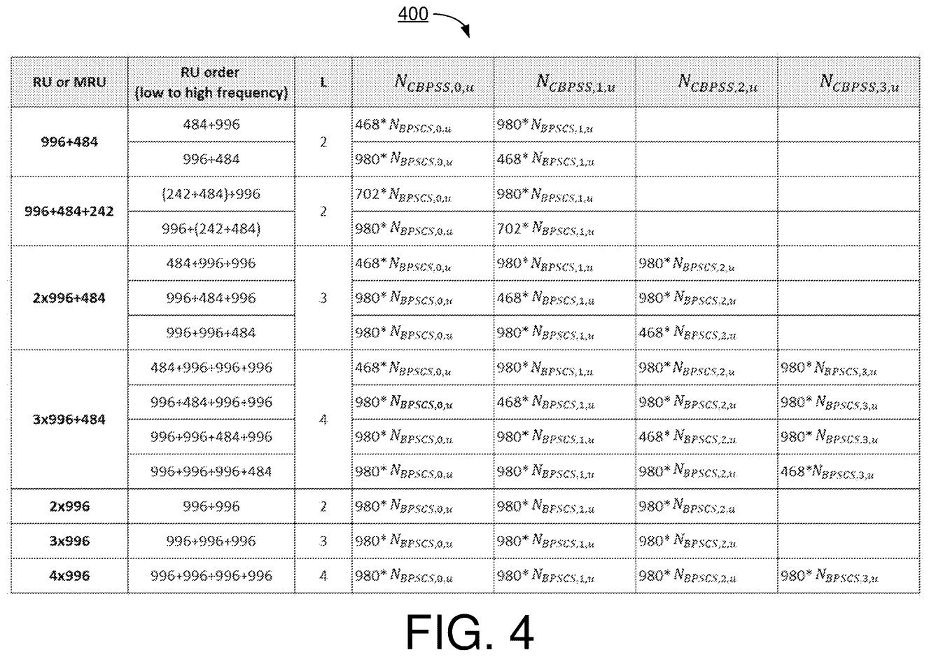

FIG. 4 illustrates an example design 400 under a proposed scheme in accordance with the present disclosure. Design 400 may pertain to parameters N_{CBPSS,I,u} for a segment parser with UEQM. Here, I denotes a frequency segment or subblock index and N_{CBPSS,I,u} denotes a number of coded bits per symbol per spatial stream for a respective frequency segment or subblock index for user u.

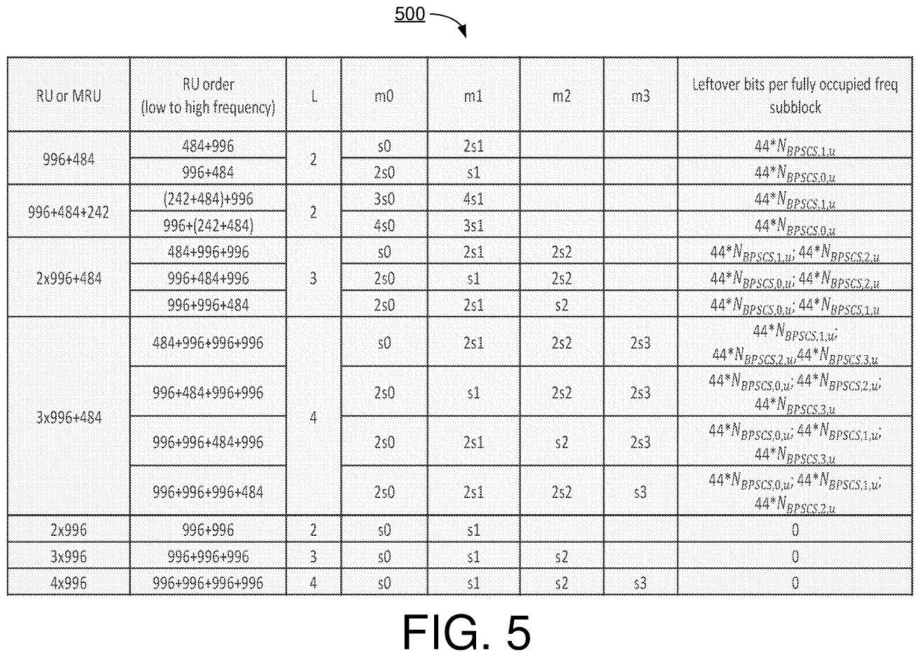

FIG. 5 illustrates an example design 500 under a proposed scheme in accordance with the present disclosure. Design 500 may pertain to proposed segment parser parameters for UEQM and unequal MCS transmission under the proposed scheme, with s_{I}=max(1, N_{BPSCS,I}/2). Here, I denotes a frequency segment or subblock index and N_{BPSCS,I} denotes a number of coded bits per subcarrier per stream for a respective frequency segment or subblock index.

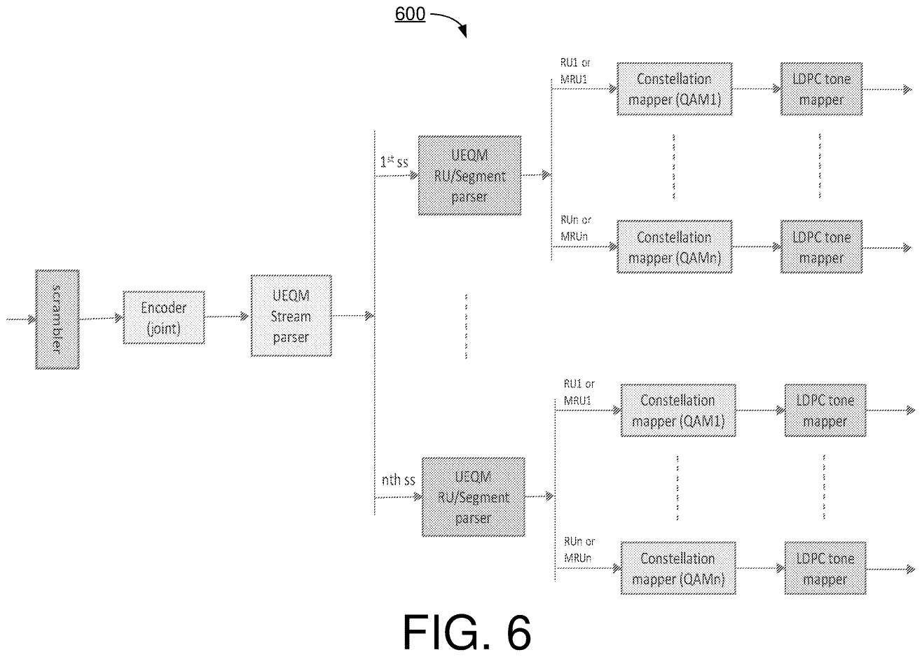

FIG. 6 illustrates an example design 600 under a proposed scheme in accordance with the present disclosure. Design 600 may pertain to a block diagram of a UEQM transmitter which may be implemented in each of STA 110 and STA 120. Referring to FIG. 6, a stream of bits may first be scrambled by a scrambler and then jointly encoded by a joint encoder before being parsed by a UEQM stream parser to a plurality of UEQM RU and segment parsers corresponding to a plurality of spatial streams (e.g., from a first spatial stream (1^{st} ss) to an n^{th} spatial stream (n^{th} ss)). Each UEQM RU and segment parser may parse RUs/MRUs to a plurality of constellation mappers, with each constellation mapper applying a respective level of QAM or MCS on the respectively parsed RU(s)/MRU(s) and then outputting to a corresponding low-density parity-check (LDPC) tone mapper. The LDPC tone mapper may perform individual/separate tone mapping for a respective RU/MRU with a different QAM. For instance, as shown in FIG. 6, different QAMs such as QAM1 through QAMn may be respectively applied to the RU1~RUn (or MRU1~MRUn) output by the respective UEQM RU and segment parser. That is, each LDPC tone mapper may be per-QAM level even within a given 80 MHz segment. Under the proposed scheme, the UEQM assignment may additionally or alternatively be per-20 MHz subchannel based or per-RU242 based.

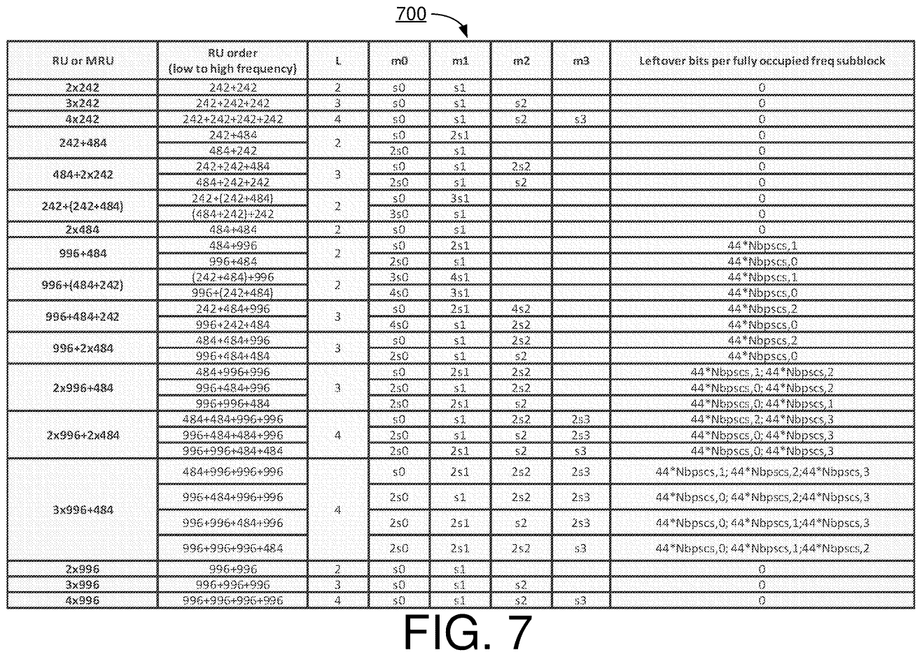

FIG. 7 illustrates an example design 700 under a proposed scheme in accordance with the present disclosure. Design 700 may pertain to a proportional round robin RU/MRU segment parser under the proposed scheme, with s_{I}=max(1, N_{BPSCS,I}/2). Here, I denotes a frequency segment or subblock index and N_{BPSCS,I} denotes a number of coded bits per subcarrier per stream for a respective frequency segment or subblock index.

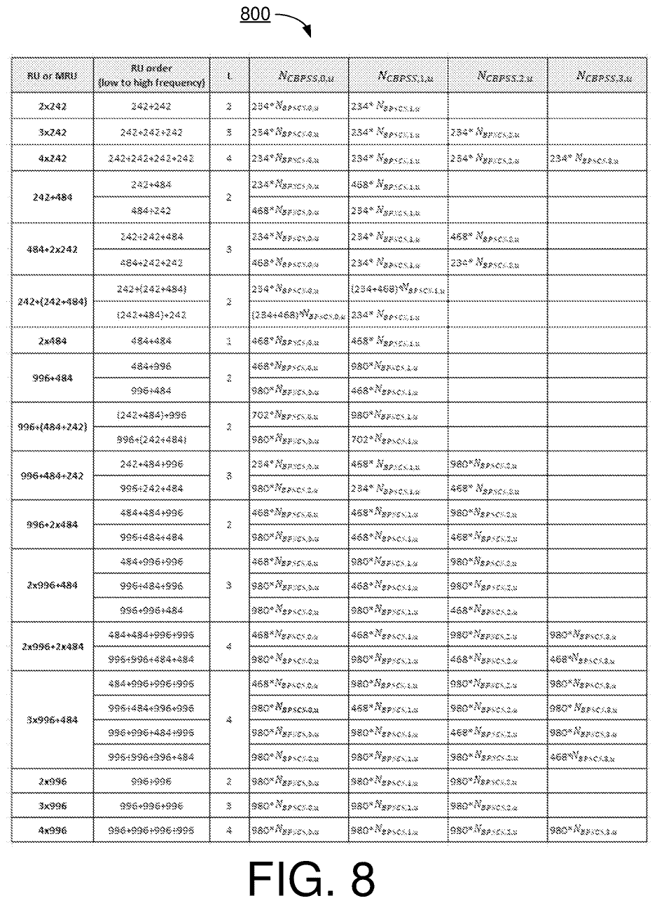

FIG. 8 illustrates an example design 800 under a proposed scheme in accordance with the present disclosure. Design 800 may pertain to a proportional round robin RU/MRU segment parser under the proposed scheme.

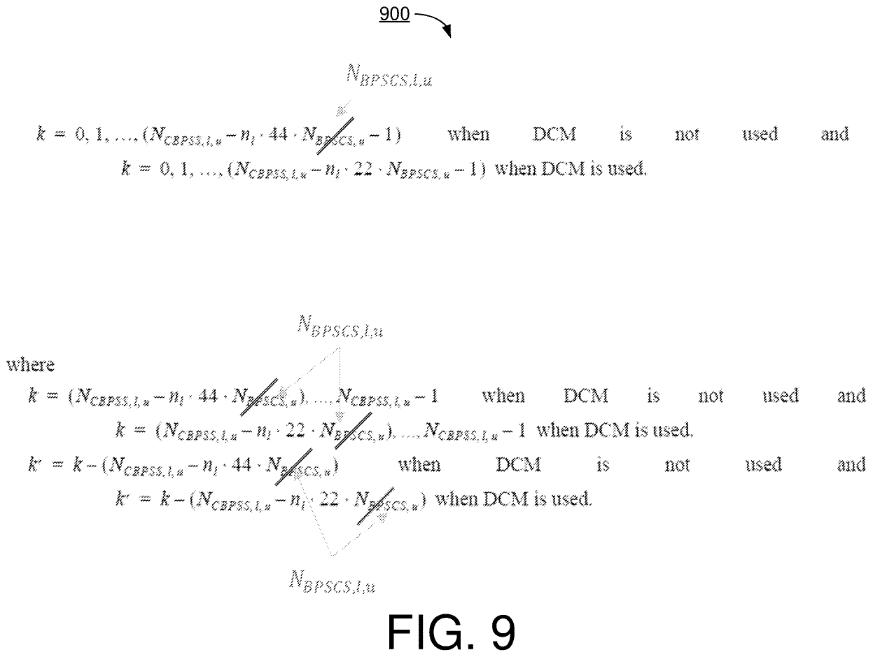

FIG. 9 illustrates an example scenario 900 under a proposed scheme in accordance with the present disclosure. Scenario 900 may pertain to segment parser processing for UEQM. Under the proposed scheme, the segment parser processing for UEQM may be operated in a way that is the same as that under IEEE 802.11be. Thus, Expression 1 shown above of segment parser in IEEE 802.11be may be reused with minor modifications by replacing all N_{BPSCS,u} with N_{BPSCS,I,u}. Here, I denotes a frequency segment or subblock index and N_{BPSCS,I} denotes a number of coded bits per subcarrier per stream for a respective frequency segment or subblock index for user u. Under the proposed scheme, N_{BPSCS,I,u} may be associated with different modulations in different RUs in different frequency segments or subblocks. Similarly, Expression 2 shown above may be reused for processing leftover bits for UEQM. FIG. 9 shows the minor modifications made to an IEEE 802.11be segment parser for supporting UEQM.

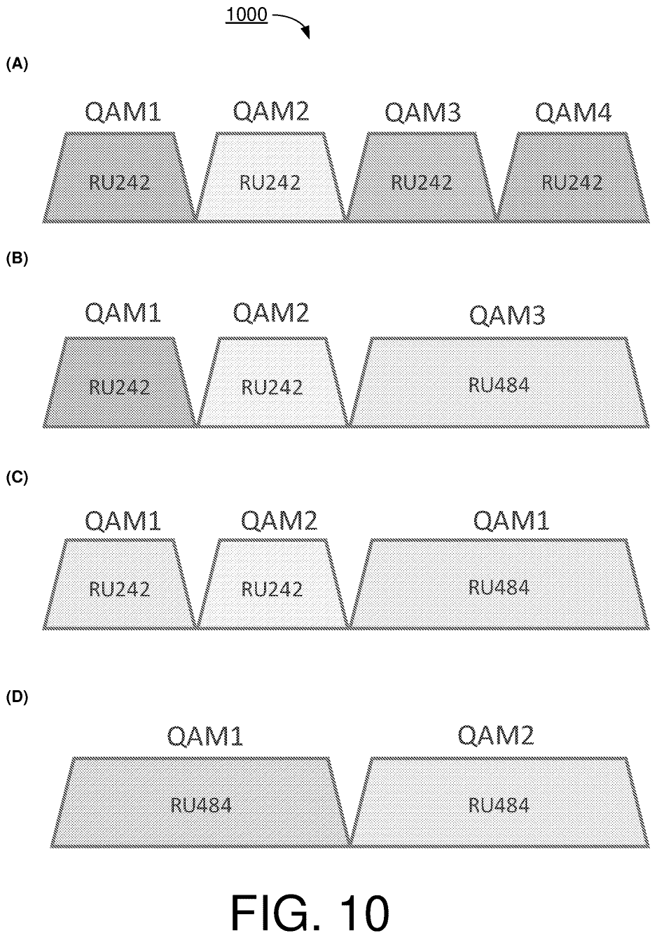

FIG. 10 illustrates an example scenario 1000 under a proposed scheme in accordance with the present disclosure. Scenario 1000 may pertain to a per-subchannel or RU242-based UEQM operation under the proposed scheme. Part (A) of FIG. 10 shows an example of a per-RU242 UEQM operation in which individual tone mapping is performed on each UEQM RU242. Referring to part (A) of FIG. 10, in this example, a first QAM level (QAM1) is applied to the first RU242 from the left, a second QAM level (QAM2) is applied to the second RU242 from the left, a third QAM level (QAM3) is applied to the third RU242 from the left, and a fourth QAM level (QAM4) is applied to the fourth RU242 from the left.

Part (B) of FIG. 10 shows an example of a RU242/RU484 UEQM operation in which individual tone mapping is performed on each UEQM RU. Referring to part (B) of FIG. 10, in this example, a first QAM level (QAM1) is applied to the first RU242 from the left, a second QAM level (QAM2) is applied to the second RU242 from the left, and a third QAM level (QAM3) is applied to the RU484.

Part (C) of FIG. 10 shows an example of a RU242 and MRU (242+484) UEQM operation in which individual tone mapping is performed on each UEQM RU/MRU. Referring to part (C) of FIG. 10, in this example, a first QAM level (QAM1) is applied to the first RU242 from the left, a second QAM level (QAM2) is applied to the second RU242 from the left, and QAM1 is also applied to the RU484.

Part (D) of FIG. 10 shows an example of a per-RU484 UEQM operation in which individual tone mapping is performed on each UEQM RU484. Referring to part (D) of FIG. 10, in this example, a first QAM level (QAM1) is applied to the first RU484 from the left, and a second QAM level (QAM2) is applied to the second RU484 from the left.

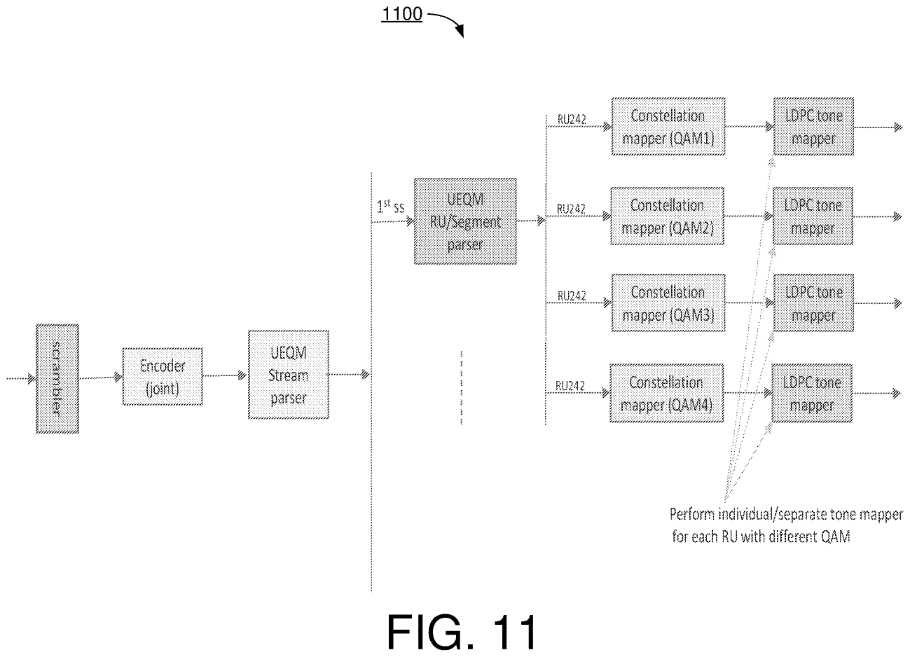

FIG. 11 illustrates an example design 1100 under a proposed scheme in accordance with the present disclosure. Design 1100 may pertain to a block diagram of a UEQM transmitter which may be implemented in each of STA 110 and STA 120. Referring to FIG. 11, a stream of bits may first be scrambled by a scrambler and then jointly encoded by a joint encoder before being parsed by a UEQM stream parser to a plurality of UEQM RU and segment parsers corresponding to a plurality of spatial streams (e.g., from 1^{st} ss to n^{th} ss). Each UEQM RU and segment parser may parse multiple (e.g., four) 242-tone RUs (RU242s) to a plurality of constellation mappers, with each constellation mapper applying a respective level of QAM or MCS on the respectively parsed RU242 and then outputting to a corresponding LDPC tone mapper. The LDPC tone mapper may perform individual/separate tone mapping for a respective RU242 to which a respective QAM is applied by the constellation mapper. For instance, as shown in FIG. 11, different QAMs such as QAM1~QAM4 may be respectively applied to the four RU242s output by the respective UEQM RU and segment parser.

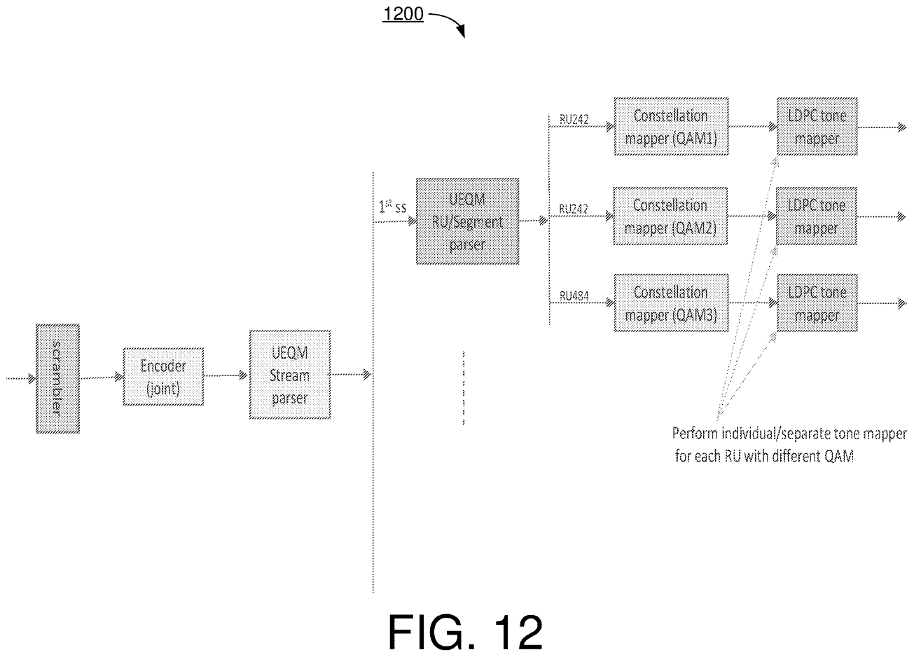

FIG. 12 illustrates an example design 1200 under a proposed scheme in accordance with the present disclosure. Design 1200 may pertain to a block diagram of a UEQM transmitter which may be implemented in each of STA 110 and STA 120. Referring to FIG. 12, a stream of bits may first be scrambled by a scrambler and then jointly encoded by a joint encoder before being parsed by a UEQM stream parser to a plurality of UEQM RU and segment parsers corresponding to a plurality of spatial streams (e.g., from 1^{st} ss to n^{th} ss). Each UEQM RU and segment parser may parse multiple (e.g., two) 242-tone RUs (RU242s) and a 484-tone RU (RU484) to a plurality of constellation mappers, with each constellation mapper applying a respective level of QAM or MCS on the respectively parsed RU242 or RU484 and then outputting to a corresponding LDPC tone mapper. The LDPC tone mapper may perform individual/separate tone mapping for a respective RU242 or RU484 to which a respective QAM is applied by the constellation mapper. For instance, as shown in FIG. 12, different QAMs such as QAM1~QAM3 may be respectively applied to the two RU242s and one RU484 output by the respective UEQM RU and segment parser.

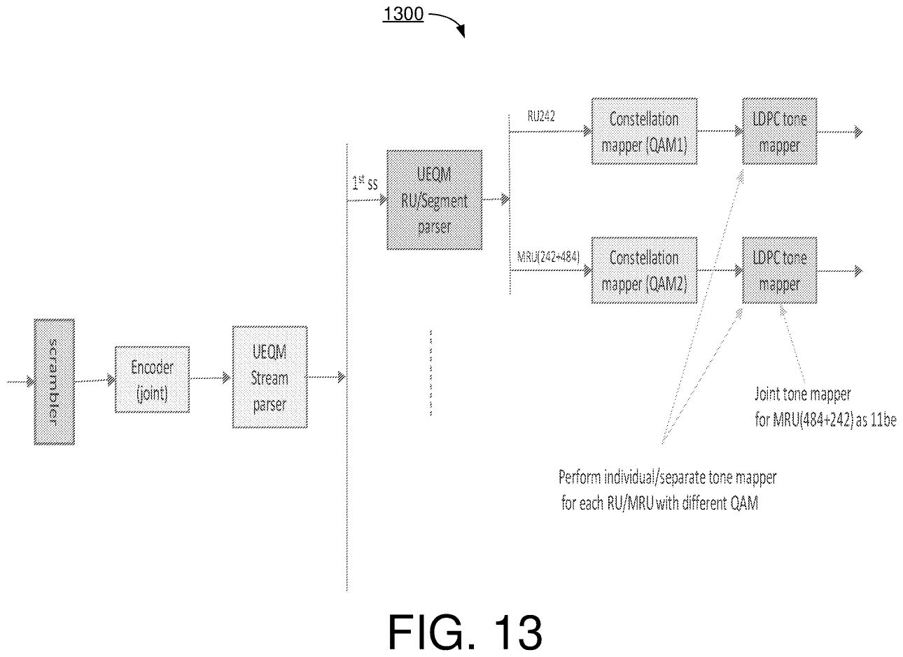

FIG. 13 illustrates an example design 1300 under a proposed scheme in accordance with the present disclosure. Design 1300 may pertain to a block diagram of a UEQM transmitter which may be implemented in each of STA 110 and STA 120. Referring to FIG. 13, a stream of bits may first be scrambled by a scrambler and then jointly encoded by a joint encoder before being parsed by a UEQM stream parser to a plurality of UEQM RU and segment parsers corresponding to a plurality of spatial streams (e.g., from 1^{st} ss to n^{th} ss). Each UEQM RU and segment parser may parse a 242-tone RU (RU242) and an MRU (242+484) to a plurality of constellation mappers, with each constellation mapper applying a respective level of QAM or MCS on the respectively parsed RU242 or MRU (242+484) and then outputting to a corresponding LDPC tone mapper. The LDPC tone mapper may perform individual/separate tone mapping for a respective RU242 or MRU (242+484) to which a respective QAM is applied by the constellation mapper. For instance, as shown in FIG. 13, different QAMs such as QAM1~QAM2 may be respectively applied to the RU242 and MRU (242+484) output by the respective UEQM RU and segment parser. In this example, the LDPC tone mapper for the MRU (242+484) may be a joint tone mapper as in IEEE 802.11be.

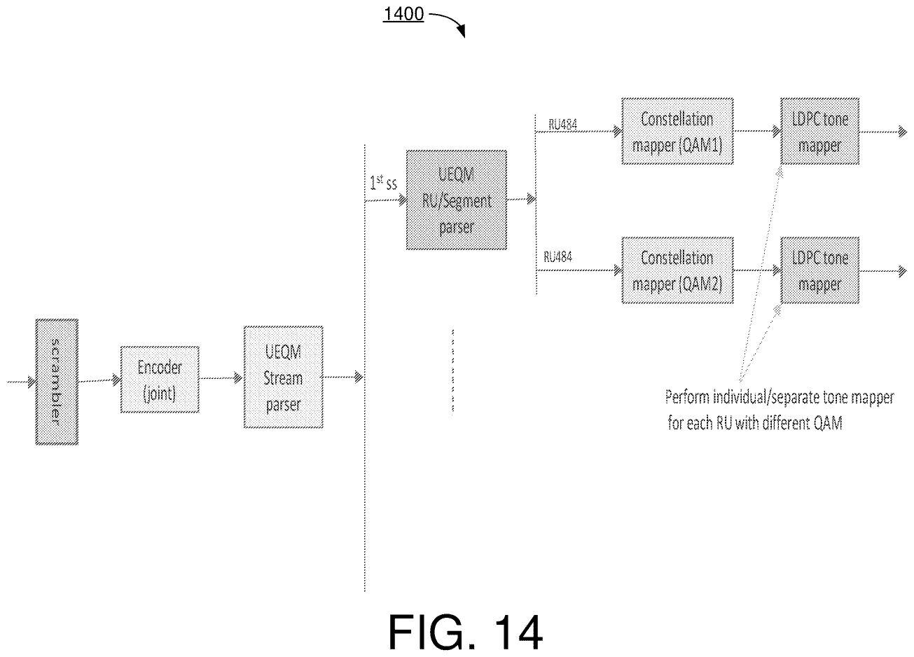

FIG. 14 illustrates an example design 1400 under a proposed scheme in accordance with the present disclosure. Design 1400 may pertain to a block diagram of a UEQM transmitter which may be implemented in each of STA 110 and STA 120. Referring to FIG. 14, a stream of bits may first be scrambled by a scrambler and then jointly encoded by a joint encoder before being parsed by a UEQM stream parser to a plurality of UEQM RU and segment parsers corresponding to a plurality of spatial streams (e.g., from 1^{st} ss to n^{th} ss). Each UEQM RU and segment parser may parse multiple (e.g., two) 484-tone RUs (RU484s) to a plurality of constellation mappers, with each constellation mapper applying a respective level of QAM or MCS on the respectively parsed RU484 and then outputting to a corresponding LDPC tone mapper.

The LDPC tone mapper may perform individual/separate tone mapping for a respective RU484 to which a respective QAM is applied by the constellation mapper. For instance, as shown in FIG. 14, different QAMs such as QAM1~QAM2 may be respectively applied to the two RU484s output by the respective UEQM RU and segment parser.

### Illustrative Implementations

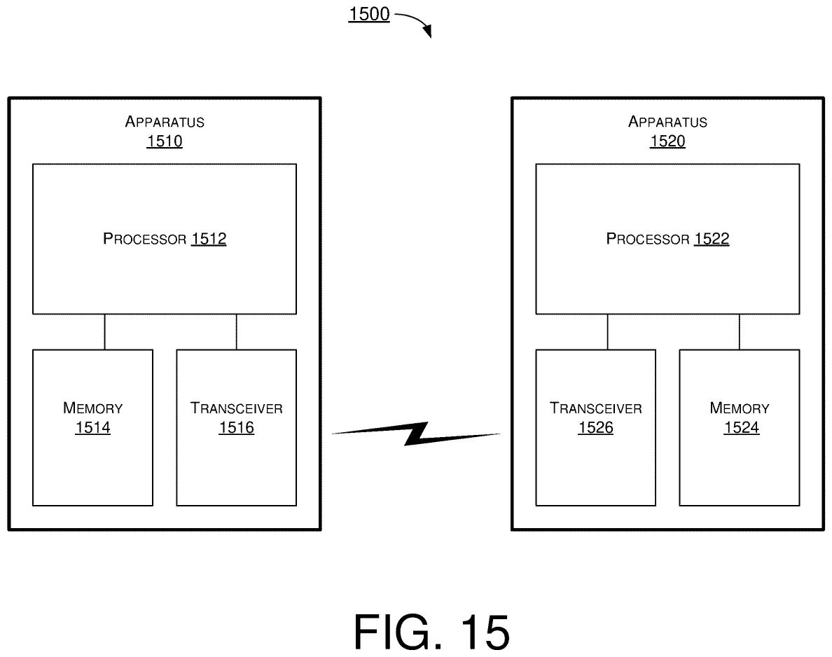

FIG. 15 illustrates an example system 1500 having at least an example apparatus 1510 and an example apparatus 1520 in accordance with an implementation of the present disclosure. Each of apparatus 1510 and apparatus 1520 may perform various functions to implement schemes, techniques, processes and methods described herein pertaining to segment parser designs for unequal modulation and unequal MCS transmission in wireless communications, including the various schemes described above with respect to various proposed designs, concepts, schemes, systems and methods described above as well as processes described below. For instance, apparatus 1510 may be implemented in STA 110 and apparatus 1520 may be implemented in STA 120, or vice versa.

Each of apparatus 1510 and apparatus 1520 may be a part of an electronic apparatus, which may be a STA or an AP, such as a portable or mobile apparatus, a wearable apparatus, a wireless communication apparatus or a computing apparatus. When implemented in a STA, each of apparatus 1510 and apparatus 1520 may be implemented in a smartphone, a smart watch, a personal digital assistant, a digital camera, or a computing equipment such as a tablet computer, a laptop computer or a notebook computer. Each of apparatus 1510 and apparatus 1520 may also be a part of a machine type apparatus, which may be an IoT apparatus such as an immobile or a stationary apparatus, a home apparatus, a wire communication apparatus or a computing apparatus. For instance, each of apparatus 1510 and apparatus 1520 may be implemented in a smart thermostat, a smart fridge, a smart door lock, a wireless speaker or a home control center. When implemented in or as a network apparatus, apparatus 1510 and/or apparatus 1520 may be implemented in a network node, such as an AP in a WLAN.

In some implementations, each of apparatus 1510 and apparatus 1520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1510 and apparatus 1520 may be implemented in or as a STA or an AP. Each of apparatus 1510 and apparatus 1520 may include at least some of those components shown in FIG. 15 such as a processor 1512 and a processor 1522, respectively, for example. Each of apparatus 1510 and apparatus 1520 may further include one or more other components not pertinent to the proposed scheme of the present disclosure (e.g., internal power supply, display device and/or user interface device), and, thus, such component(s) of apparatus 1510 and apparatus 1520 are neither shown in FIG. 15 nor described below in the interest of simplicity and brevity.

In one aspect, each of processor 1512 and processor 1522 may be implemented in the form of one or more single-core processors, one or more multi-core processors, one or more RISC processors or one or more CISC processors. That is, even though a singular term “a processor” is used herein to refer to processor 1512 and processor 1522, each of processor 1512 and processor 1522 may include multiple processors in some implementations and a single processor in other implementations in accordance with the present disclosure. In another aspect, each of processor 1512 and processor 1522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1512 and processor 1522 is a special-purpose machine specifically designed, arranged and configured to perform specific tasks including those pertaining to segment parser designs for unequal modulation and unequal MCS transmission in wireless communications in accordance with various implementations of the present disclosure. For instance, each of processor 1512 and 1522 may be configured with electronic circuitry implementing one or more of the designs of a UEQM transmitter (e.g., one or more of designs 600, 1100, 1200, 1300 and 1400) for transmission of MRUs as described herein.

In some implementations, apparatus 1510 may also include a transceiver 1516 coupled to processor 1512. Transceiver 1516 may include a transmitter capable of wirelessly transmitting and a receiver capable of wirelessly receiving data. In some implementations, apparatus 1520 may also include a transceiver 1526 coupled to processor 1522. Transceiver 1526 may include a transmitter capable of wirelessly transmitting and a receiver capable of wirelessly receiving data. It is noteworthy that, although transceiver 1516 and transceiver 1526 are illustrated as being external to and separate from processor 1512 and processor 1522, respectively, in some implementations, transceiver 1516 may be an integral part of processor 1512 as a system on chip (SoC) and/or transceiver 1526 may be an integral part of processor 1522 as a SoC.

In some implementations, apparatus 1510 may further include a memory 1514 coupled to processor 1512 and capable of being accessed by processor 1512 and storing data therein. In some implementations, apparatus 1520 may further include a memory 1524 coupled to processor 1522 and capable of being accessed by processor 1522 and storing data therein. Each of memory 1514 and memory 1524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1514 and memory 1524 may include a type of read-only memory (ROM) such as mask ROM, programmable ROM (PROM), erasable programmable ROM (EPROM) and/or electrically erasable programmable ROM (EEPROM). Alternatively, or additionally, each of memory 1514 and memory 1524 may include a type of non-volatile random-access memory (NVRAM) such as flash memory, solid-state memory, ferroelectric RAM (FeRAM), magnetoresistive RAM (MRAM) and/or phase-change memory.

Each of apparatus 1510 and apparatus 1520 may be a communication entity capable of communicating with each other using various proposed schemes in accordance with the present disclosure. For illustrative purposes and without limitation, a description of capabilities of apparatus 1510, as STA 110, and apparatus 1520, as STA 120, is provided below in the context of process 1600. It is noteworthy that, although a detailed description of capabilities, functionalities and/or technical features of apparatus 1510 is provided below, the same may be applied to apparatus 1520 although a detailed description thereof is not provided solely in the interest of brevity. It is also noteworthy that, although the example implementations described below are provided in the context of WLAN, the same may be implemented in other types of networks.

### Illustrative Processes

FIG. 16 illustrates an example process 1600 in accordance with an implementation of the present disclosure. Process 1600 may represent an aspect of implementing various proposed designs, concepts, schemes, systems and methods described above. More specifically, process 1600 may represent an aspect of the proposed concepts and schemes pertaining to segment parser designs for unequal modulation and unequal MCS transmission in wireless communications in accordance with the present disclosure. Process 1600 may include one or more operations, actions, or functions as illustrated by one or more of blocks 1610 and 1620. Although illustrated as discrete blocks, various blocks of process 1600 may be divided into additional blocks, combined into fewer blocks, or eliminated, depending on the desired implementation. Moreover, the blocks/sub-blocks of process 1600 may be executed in the order shown in FIG. 16 or, alternatively, in a different order. Furthermore, one or more of the blocks/sub-blocks of process 1600 may be executed repeatedly or iteratively. Process 1600 may be implemented by or in apparatus 1510 and apparatus 1520 as well as any variations thereof. Solely for illustrative purposes and without limiting the scope, process 1600 is described below in the context of apparatus 1510 implemented in or as STA 110 and apparatus 1520 implemented in or as STA 120 of a wireless network such as a WLAN in network environment 100 in accordance with one or more of IEEE 802.11 standards. Process 1600 may begin at block 1610.

At 1610, process 1600 may involve processor 1512 of apparatus 1510 (e.g., STA 110) generating an MRU comprising an aggregate of a plurality of RUs. Process 1600 may proceed from 1610 to 1620.

At 1620, process 1600 may involve processor 1512 transmitting, via transceiver 1516, the MRU with UEQM or with unequal MCS.

In some implementations, in transmitting the MRU with the UEQM or unequal MCS, process 1600 may involve processor 1512 applying different QAM levels or MCS levels to the plurality of RUs of the MRU.

In some implementations, the UEQM or unequal MCS may be applied on a per-80 MHz segment basis. In some implementations, the MRU may include at least a first RU (or a first MRU) in a first 80 MHz segment and at least a second RU (or a second MRU) in a second 80 MHz segment. In such cases, a first QAM level or MCS level may be applied to the first RU or the first MRU, and a second QAM level or MCS level, different than the first QAM level or MCS level, may be applied to the second RU or the second MRU.

In some implementations, the UEQM or unequal MCS may be applied on a per-20 MHz subchannel basis. In some implementations, the MRU may include at least a first RU in a first 20 MHz subchannel and at least a second RU in a second 20 MHz subchannel. In such cases, a first QAM level or MCS level may be applied to the first RU, and a second QAM level or MCS level, different than the first QAM level or MCS level, may be applied to the second RU.

In some implementations, the UEQM or unequal MCS may be applied on a per-RU242 basis. In some implementations, the MRU may include at least a first RU242 and at least a second RU242. In such cases, a first QAM level or MCS level may be applied to the first RU242, and a second QAM level or MCS level, different than the first QAM level or MCS level, may be applied to the second RU242.

In some implementations, the UEQM or unequal MCS may be applied on a per-RU484 basis. In some implementations, the MRU may include at least a first RU484 and at least a second RU484. In such cases, a first QAM level or MCS level may be applied to the first RU484, and a second QAM level or MCS level, different than the first QAM level or MCS level, may be applied to the second RU484.

In some implementations, the MRU may include at least a first RU 242, a second RU242 and a RU484. In such cases, a first QAM level or MCS level may be applied to the first RU242, a second QAM level or MCS level, different than the first QAM level or MCS level, may be applied to the second RU242, and a third QAM level or MCS level, different than the first and second QAM levels or MCS levels, may be applied to the RU484.

In other implementations, the MRU may include at least a first RU242, a second RU242 and a RU484. In such cases, a first QAM level or MCS level may be applied to the first RU242 and the RU484, and a second QAM level or MCS level, different than the first QAM level or MCS level, may be applied to the second RU242.

In other implementations, in transmitting the MRU with the UEQM or unequal MCS, process 1600 may involve processor 1512 performing certain operations. For instance, process 1600 may involve processor 1512 parsing, by a stream parser, a stream of coded bits to a plurality of RU and segment parser. Additionally, process 1600 may involve processor 1512 parsing, by each of the plurality of RU and segment parsers, respective coded bits to a plurality of constellation mappers. Moreover, process 1600 may involve processor 1512 applying, by the plurality of constellation mappers, different quadrature amplitude modulation (QAM) levels or MCS levels to respective parsed coded bits. Furthermore, process 1600 may involve processor 1512 performing LDPC tone mapping on an output of each of the plurality of constellation mappers.

In other implementations, the MRU may include multiple RU242s.

In other implementations, the MRU may include multiple RU484s.

In other implementations, the MRU may include multiple RU996s.

In other implementations, the MRU may include at least one RU242 and at least one RU484.

In other implementations, the MRU may include at least one RU484 and at least one RU996.

In other implementations, the MRU may include at least one RU242, at least one RU484 and at least one RU996.

### Additional Notes

The herein-described subject matter sometimes illustrates different components contained within, or connected with, different other components. It is to be understood that such depicted architectures are merely examples, and that in fact many other architectures can be implemented which achieve the same functionality.

In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a multi-resource unit (MRU) comprising an aggregate of a plurality of resource units (RUs); and
transmitting the MRU with unequal modulation (UEQM) or with unequal modulation and coding scheme (MCS).

2. The method of claim 1, wherein the transmitting of the MRU with the UEQM or unequal MCS comprises applying different quadrature amplitude modulation (QAM) levels or MCS levels to the plurality of RUs of the MRU.

3. The method of claim 2, wherein the UEQM or unequal MCS is applied on a per-80 MHz segment basis, wherein the MRU comprises at least a first RU or a first MRU in a first 80 MHz segment and at least a second RU or a second MRU in a second 80 MHz segment, and wherein:
a first QAM level or MCS level is applied to the first RU or the first MRU, and
a second QAM level or MCS level, different than the first QAM level or MCS level, is applied to the second RU or the second MRU.

4. The method of claim 2, wherein the UEQM or unequal MCS is applied on a per-20 MHz subchannel basis, wherein the MRU comprises at least a first RU in a first 20 MHz subchannel and at least a second RU in a second 20 MHz subchannel, and wherein:
a first QAM level or MCS level is applied to the first RU, and
a second QAM level or MCS level, different than the first QAM level or MCS level, is applied to the second RU.

5. The method of claim 2, wherein the UEQM or unequal MCS is applied on a per-242-tone RU (RU242) basis, wherein the MRU comprises at least a first RU242 and at least a second RU242, and wherein:
a first QAM level or MCS level is applied to the first RU242, and
a second QAM level or MCS level, different than the first QAM level or MCS level, is applied to the second RU242.

6. The method of claim 2, wherein the UEQM or unequal MCS is applied on a per-484-tone RU (RU484) basis, wherein the MRU comprises at least a first RU484 and at least a second RU484, and wherein:
a first QAM level or MCS level is applied to the first RU484, and
a second QAM level or MCS level, different than the first QAM level or MCS level, is applied to the second RU484.

7. The method of claim 2, wherein the MRU comprises at least a first 242-tone (RU242), a second RU242 and a 484-tone RU (RU484), and wherein:
a first QAM level or MCS level is applied to the first RU242,
a second QAM level or MCS level, different than the first QAM level or MCS level, is applied to the second RU242, and
a third QAM level or MCS level, different than the first and second QAM levels or MCS levels, is applied to the RU484.

8. The method of claim 2, wherein the MRU comprises at least a first 242-tone (RU242), a second RU242 and a 484-tone RU (RU484), and wherein:
a first QAM level or MCS level is applied to the first RU242 and the RU484, and
a second QAM level or MCS level, different than the first QAM level or MCS level, is applied to the second RU242.

9. The method of claim 1, wherein the transmitting of the MRU with the UEQM or unequal MCS comprises:
parsing, by a stream parser, a stream of coded bits to a plurality of RU and segment parser;
parsing, by each of the plurality of RU and segment parsers, respective coded bits to a plurality of constellation mappers;
applying, by the plurality of constellation mappers, different quadrature amplitude modulation (QAM) levels or MCS levels to respective parsed coded bits; and
performing low-density parity-check (LDPC) tone mapping on an output of each of the plurality of constellation mappers.

10. The method of claim 1, wherein the MRU comprises multiple 242-tone RUs (RU242s).

11. The method of claim 1, wherein the MRU comprises multiple 484-tone RUs (RU484s).

12. The method of claim 1, wherein the MRU comprises multiple 996-tone RUs (RU996s).

13. The method of claim 1, wherein the MRU comprises at least one 242-tone RU (RU242) and at least one 484-tone RU (RU484).

14. The method of claim 1, wherein the MRU comprises at least one 484-tone RU (RU484) and at least one 996-tone RU (RU996).

15. The method of claim 1, wherein the MRU comprises at least one 242-tone RU (RU242), at least one 484-tone RU (RU484) and at least one 996-tone RU (RU996).

16. An apparatus, comprising:
a transceiver configured to communicate wirelessly; and
a processor coupled to the transceiver and configured to perform operations comprising:
generating a multi-resource unit (MRU) comprising an aggregate of a plurality of resource units (RUs); and
transmitting, via the transceiver, the MRU with unequal modulation (UEQM) or with unequal modulation and coding scheme (MCS).

17. The apparatus of claim 16, wherein the transmitting of the MRU with the UEQM or unequal MCS comprises applying different quadrature amplitude modulation (QAM) levels or MCS levels to the plurality of RUs of the MRU.

18. The apparatus of claim 17, wherein the UEQM or unequal MCS is applied on a per-80 MHz segment basis, wherein the MRU comprises at least a first RU or a first MRU in a first 80 MHz segment and at least a second RU or a second MRU in a second 80 MHz segment, and wherein:
a first QAM level or MCS level is applied to the first RU or the first MRU, and
a second QAM level or MCS level, different than the first QAM level or MCS level, is applied to the second RU or the second MRU.

19. The apparatus of claim 17, wherein the UEQM or unequal MCS is applied on a per-20 MHz subchannel basis, wherein the MRU comprises at least a first RU in a first 20 MHz subchannel and at least a second RU in a second 20 MHz subchannel, and wherein:
a first QAM level or MCS level is applied to the first RU, and
a second QAM level or MCS level, different than the first QAM level or MCS level, is applied to the second RU.

20. The apparatus of claim 17, wherein the UEQM or unequal MCS is applied on a per-242-tone RU (RU242) or per-484-tone RU (RU484) basis, wherein the MRU comprises at least a first RU242 or RU484 and at least a second RU242 or RU484, and wherein:
a first QAM level or MCS level is applied to the first RU242 or RU484, and
a second QAM level or MCS level, different than the first QAM level or MCS level, is applied to the second RU242 or RU484.
